(19) United States
(12) Patent Application Publication
(10) Pub. No.: US 2011/0159318 A1
(43) Pub. Date: Jun. 30, 2011

(54) GLASS SUBSTRATE FOR INFORMATION RECORDING MEDIUM AND MAGNETIC DISK

(75) Inventors: Jun ENDO, Chiyoda-ku (JP); Tetsuya Nakashima, Chiyoda-ku (JP)

(73) Assignee: ASAHI GLASS COMPANY, Limited, Chiyoda-ku (JP)

(21) Appl. No.: 12/959,726

(22) Filed: Dec. 3, 2010

(30) Foreign Application Priority Data
Dec. 24, 2009 (JP) 2009-292575

(51) Int. Cl. G11B 5/735

(52) U.S. Cl. 428/846.9; 428/800

(57) ABSTRACT

A glass substrate for an information recording medium, comprising an alkali aluminosilicate glass, wherein the β—OH value is at least 0.20 mm⁻¹.

The present invention relates to a glass substrate to be used for an information recording medium such as a magnetic disk (hard disk), and a magnetic disk.

Glass substrates are widely used as substrates for information recording media, particularly as substrates for magnetic disks, and glass comprising, as represented by mass %, from 47 to 60% of SiO₂, from 8 to 20% Al₂O₃, from 2 to 8% of Na₂O, from 1 to 15% of K₂O, from 1 to 6% of TiO₂, from 1 to 5% of ZrO₂, etc., has been proposed.

Patent Document 1: WO2008/117758

A glass substrate for a magnetic disk is required to have appropriate expansion coefficient, Young's modulus, etc. and in addition, is required to be free from a remarkable change of a surface condition during storage which may lead to peeling of films such as a base film, a magnetic film and a protective film formed on the substrate, i.e. to have weather resistance.

It is an object of the present invention to provide a glass substrate for a magnetic disk having improved weather resistance.

The present invention provides a glass substrate for an information recording medium, comprising an alkali aluminosilicate glass, wherein the β—OH value is at least 0.20 mm⁻¹.

The present invention further provides the above glass substrate for an information recording medium, wherein the alkali aluminosilicate glass has an alkali metal oxide content of from 15 to 26 mol %.

The present invention further provides the above glass substrate for an information recording medium, wherein the alkali aluminosilicate glass comprises, as represented by mol % based on the following oxides, from 64 to 67% of SiO₂, from 8 to 10% of Al₂O₃, from 10 to 13% of Li₂O, from 9 to 12% of Na₂O, from 0 to 2% of K₂O and from 2 to 4% of ZrO₂, provided that the total content of Li₂O, Na₂O and K₂O is from 21 to 25%. Further, “comprising from 0 to 2% of K₂O” for example means that K₂O is not essential but may be contained in an amount of at most 2%.

Still further, the present invention provides a magnetic disk comprising the above glass substrate for an information recording medium and a magnetic recording layer formed on the glass substrate.

The weather resistance of the glass substrate for an information recording medium is mainly dominated by the composition of the glass. However, the present inventors have found that the weather resistance is improved by increasing the β—OH value even with the same glass composition, and accomplished the present invention.

According to the present invention, a glass substrate for an information recording medium excellent in the weather resistance can be obtained. By the glass substrate, films such as a base film, a magnetic film and a protective film formed on the substrate are less likely to be peeled.

Now, the present invention will be described in detail with reference to the preferred embodiments.

Glass (hereinafter referred to as glass of the present invention) for the glass substrate for an information recording medium of the present invention (hereinafter referred to as a glass substrate of the present invention) has a density d of preferably at most 2.60 g/cm³. If the density exceeds 2.60 g/cm³, motor load during disk rotation becomes high, and power consumption becomes large. Further, disk rotation is likely to be unstable. The density is preferably at most 2.54 g/cm³.

The glass of the present invention has a Young's modulus E of preferably at least 76 GPa. If the Young's modulus is less than 76 GPa, the glass tends to warp or deflect or flutter during disk rotation, and it may be difficult to obtain information recording media having high recording density. E is more preferably at least 77 GPa.

The glass of the present invention has a specific modulus E/d of preferably at least 28 MNm/kg. If E/d is less than 28 MNm/kg, the glass tends to warp or deflect or flutter during disk rotation, and it may be difficult to obtain information recording media having high recording density. E/d is more preferably at least 30 MNm/kg.

The glass transition temperature T_{g} of the glass of the present invention is preferably at least 450° C. If T_{g} is lower than 450° C., the temperature for the heat treatment for forming a magnetic layer cannot be made sufficiently high, and it may be difficult to increase the magnetic coercive force of the magnetic layer. T_{g} is more preferably at least 460° C.

The average linear expansion coefficient α of the glass of the present invention in a temperature range of from −50 to 70° C. is preferably at least 56×10⁻⁷/° C. If a is lower than 56×10⁻⁷/° C., the difference in the thermal expansion coefficient from other members such as a drive made of metal becomes large, and the substrate tends to fracture due to a stress caused by temperature change. α is more preferably at least 58×10⁻⁷/° C. Typically, α is at most 100×10⁻⁷/° C.

The β—OH value of the glass substrate of the present invention is considered to be at least 0.20 mm⁻¹ in order to improve the weather resistance. If the β—OH value is is less than 0.20 mm⁻¹, an effect of improving the weather resistance is hardly obtained. The β—OH value is preferably at least 0.24 mm⁻¹, and when it is at least 0.30 mm⁻¹, the effect will be more remarkable. Typically, the β—OH value is at least 0.34 mm⁻¹.

The β—OH value in the present invention is an index of the hydroxy group content in glass and is calculated from the following formula based on the transmittance measured by FT-IR (Fourier transform infrared spectroscopy).

β—OH value=(1/X)log₁₀(T1/T2)

wherein X is the thickness (mm) of a sample, T1 is the transmittance (%) at a reference wave number of 4,000 cm⁻¹, and T2 is the minimum value (%) of the transmittance in the vicinity of the hydroxy group absorption wave number 3,500 CM⁻¹ (within a range of from 3,300 cm⁻¹ to 3,700 cm⁻¹).

The higher the β—OH value, the higher the hydroxy group content in the glass.

Now, the glass of the present invention will be described with reference to the contents as represented by mol percentage.

The glass of the present invention is an alkali aluminosilicate glass and typically has a SiO₂ content of from 61 to 71%, an Al₂O₃ content of from 7 to 17% and an alkali metal oxide content of from 15 to 26%.

If the SiO₂ content is less than 61%, the acid resistance will be decreased, d will be high, or the liquid phase temperature will rise, whereby the glass becomes unstable. If it exceeds 71%, the temperature T₂ at which the viscosity becomes 10² dPa·s and the temperature T₄ at which the viscosity becomes 10⁴ dPa·s will rise, and it will be difficult to melt and form glass, E or E/d will be decreased, or α will be low.

If the Al₂O₃ content is less than 7%, the weather resistance will be decreased, E or E/d will be decreased, or T_{g} will be low. If it exceeds 17%, the acid resistance will be decreased, or T₂ and T₄ will rise, whereby it will be difficult to melt and form glass, a will be low, or the liquid phase temperature will be too high.

The alkali metal oxide is commonly Li₂O, Na₂O or K₂O. If the total content of alkali metal oxides is less than 15%, a will be low, or the glass melting properties will be decreased. If it exceeds 26%, the weather resistance will be decreased.

It is preferred that the Li₂O content is from 6 to 16%, the Na₂O content is from 2 to 13% and the K₂O content is from 0 to 8%.

If the Li₂O content is less than 6%, a may be low, or the glass melting properties may be decreased. If it exceeds 16%, the weather resistance or T_{g} may be decreased.

It the Na₂O content is less than 2%, α may be low, or the glass melting properties may be decreased. If it exceeds 13%, the weather resistance or T_{g} may be decreased.

K₂O is not essential but may be contained up to 8% so as to increase a or to improve the glass melting properties. If the K₂O content exceeds 8%, the weather resistance may be decreased, or E or E/d may be decreased.

This alkali aluminosilicate glass may contain components other than SiO₂, Al₂O₃ and alkali metal oxides within a range not to impair properties as a substrate for an information recording medium, but the total content of such components is typically at most 8%.

As one preferred embodiment of the glass of the present invention, glass comprising from 64 to 67% of SiO₂, from 8 to 10% of Al₂O₃, from 10 to 13% of Li₂O, from 9 to 12% of Na₂O, from 0 to 2% of K₂O and from 2 to 4% of ZrO₂, provided that the total content of Li₂O, Na₂O and K₂O, i.e. Li₂O+Na₂O+K₂O is from 21 to 25% (hereinafter this glass will be referred to as glass A of the present invention) may be mentioned.

Now, the composition of glass A of the present invention will be described.

SiO₂ is a component to form the glass structure and is essential. If its content is less than 64%, the acid resistance will be decreased, d will be high, or the liquid phase temperature will rise, whereby the glass will be unstable. If it exceeds 67%, T₂ and T₄ will rise, and it will be difficult to melt and form glass, E or E/d will be decreased, or α will be low.

Al₂O₃ has an effect to increase the weather resistance and is essential. If its content is less than 8%, the above effect will be low, E or E/d will be decreased, or T_{g} will be low. If it exceeds 10%, the acid resistance will be decreased, T₂ and T₄ will rise, and it will be difficult to melt and form glass, a will be low, or the liquid phase temperature will be too high.

Li₂O has an effect to increase E, E/d or α or to improve the glass melting properties and is essential. If its content is less than 10%, the above effects will be low. If it exceeds 13%, the weather resistance will be decreased, or T_{g} will be low.

Na₂O has an effect to increase a or to improve the glass melting properties and is essential. If its content is less than 9%, the above effects will be low. If it exceeds 12%, the weather resistance will be decreased, or T_{g} will be low.

Although K₂O is not essential, it has an effect to increase a or to improve the glass melting properties and may be contained up to 2%. If its content exceeds 2%, the weather resistance will be decreased, or E or E/d will be decreased. The content of K₂O if contained is preferably at least 0.1%.

If the total content of Li₂O, Na₂O and K₂O i.e. Li₂O+Na₂O+K₂O (hereinafter referred to as R₂O) is less than 21%, a will be low, or the glass melting properties will be decreased. If R₂O exceeds 25%, the weather resistance will be decreased.

ZrO₂ has an effect to increase E, E/d or T_{g}, to increase the weather resistance or to improve the glass melting properties and is essential. If its content is less than 2%, the above effects will be low. If it exceeds 4%, d may be high, or the liquid phase temperature may be too high.

The glass of the present invention essentially comprises the above components and may contain other components within a range not to impair the object of the present invention. In such a case, the total content of such other components is preferably at most 2%, more preferably at most 1%, particularly preferably at most 0.5%.

Now, such other components will be exemplified.

Although MgO is not essential, it has an effect to increase E, E/d or α while maintaining the weather resistance, to prevent the glass from being brittle or to improve the glass melting properties, and may be contained up to 2%. If its content exceeds 2%, the liquid phase temperature will be too high. It is more preferably at most 1%, particularly preferably at most 0.5%. Typically no MgO is contained.

Although CaO is not essential, it has an effect to increase a while maintaining the weather resistance, or to improve the glass melting properties, and may be contained up to 2%. If its content exceeds 2%, d may be high, E may be decreased, or the liquid phase temperature may be too high. It is more preferably at most 1%, particularly preferably at most 0.5%. Typically no CaO is contained.

SrO may be contained within a range of at most 2% so as to increase a or to improve the glass melting properties. If its content exceeds 2%, d may be high, or the is glass may be brittle. It is more preferably at most 1%, particularly preferably at most 0.5%. Typically no SrO is contained.

BaO may be contained within a range of at most 2% so as to increase a or to improve the glass melting properties. If its content exceeds 2%, d may be high, or the glass may be brittle. It is more preferably at most 1%, particularly preferably at most 0.5%. Typically no BaO is contained.

TiO₂ may be contained within a range of less than 2% for the purpose of increasing E, E/d or T_{g}, increasing the weather resistance, etc. If its content is 2% or higher, T_{L} may be too high, or a phase separation phenomenon tends to occur. It is more preferably at most 1%, particularly preferably at most 0.5%. Typically no TiO₂ is contained.

B₂O₃ may be contained within a range of at most 2% for the purpose of increasing E or E/d, increasing the weather resistance, improving the glass melting properties, etc. If its content exceeds 2%, a phase separation phenomenon tends to occur. It is more preferably at most 1%, particularly preferably at most 0.5%. Typically no B₂O₃ is contained.

La₂O₃ may be contained for the purpose of improving E while maintaining the weather resistance, etc., but in such a case, its content is preferably at most 2%. If it exceeds 2%, d may be high, or the liquid phase temperature may be too high. It is more preferably at most 1%, particularly preferably at most 0.5%. Typically no La₂O₃ is contained.

Nb₂O₅ may be contained for the purpose of improving E while maintaining the weather resistance, etc., but in such a case, its content is preferably at most 2%. If it exceeds 2%, d may be high, or the liquid phase temperature may be too high. It is more preferably at most 1%, particularly preferably at most 0.5%. Typically no Nb₂O₅ is contained.

RE₂O₃ i.e. an oxide of at least one rare earth selected from the group consisting of Sc, Y, La, Ce, Pr, Nd, Sm, Eu, Gd, Tb, Dy, Ho, Er, Tm, Yb and Lu may be contained up to less than 1% in total.

A refining agent such as SO₃, Cl, As₂O₃, Sb₂O₃ or SnO₂ may be contained up to 2% in total.

A colorant such as Fe₂O₃, CO₃O₄ or NiO may be contained up to 2% in total.

According to another preferred embodiment of the glass of the present invention, glass comprising from 64 to 69% of SiO₂, from 9 to 11% of Al₂O₃, from 6 to 9% of Li₂O, from 9 to 13% of Na₂O, from 0 to 2% of K₂O, from 0 to 4% of MgO, from 1 to 5% of CaO and from 0 to 2% of ZrO₂, provided that Li₂O+Na₂O+K₂O is from 16 to 20%, glass comprising from 66 to 71% of SiO₂, from 7 to 9% of Al₂O₃, from 0 to 3% of B₂O₃, from 12 to 16% of Li₂O, from 2 to 5% of Na₂O, from 0 to 3% of K₂O, from 0 to 5% of MgO, from 0 to 3% of TiO₂, from 0 to 2% of ZrO₂, from 0 to 2% of La₂O₃ and from 0 to 2% of Nb₂O₅, provided that Li₂O+Na₂O+K₂O is from 16 to 21%, or glass comprising from 61 to 66% of SiO₂, from 11.5 to 17% of Al₂O₃, from 8 to 16% of Li₂O, from 2 to 8% of Na₂O, from 2.5 to 8% of K₂O, from 0 to 6% of MgO, from 0 to 4% of TiO₂ and from 0 to 3% of ZrO₂, provided that Al₂O₃+MgO+TiO₂ is at least 12% and Li₂O+Na₂O+K₂O is from 16 to 23%, and having a B₂O₃ content of less than 1% if contained, may, for example be mentioned.

The glass substrate of the present invention is usually a circular glass plate.

The weather resistance of the glass substrate of the present invention is evaluated by C_{R}=C_{Li}+C_{Na}+C_{K} where when the glass substrate is left under steam atmosphere at 120° C. under 0.2 MPa for 20 hours, the amount of Li, the amount of Na and the amount K, which precipitate on the glass surface are represented as C_{Li}, C_{Na} and C_{K}, respectively.

In a case where the glass of the present invention is the above glass A, C_{R} of the glass substrate of the present invention is preferably at most 8.3 nmol/cm². If C_{R} exceeds 8.3 nmol/cm², films such as a base film, a magnetic film and a protective film formed on the substrate are likely to be peeled.

The glass substrate of the present invention is typically used as a glass substrate for a magnetic disk.

The glass substrate for a magnetic disk is widely used for a 2.5 inch substrate (outside diameter of a glass substrate: 65 mm) used for laptop computers, etc. or a 1.8 inch substrate (outside diameter of a glass substrate: 48 mm) used for portable MP3 players, etc., and its market is expanding year by year, while it is demanded to supply the glass substrate at low price. Glass to be used for such a glass substrate is preferably one which is suitable for mass production.

Mass production of plate glass is widely carried out by a continuous forming method such as a float process, a fusion method or a down draw method. Since the glass of the present invention includes glass which can be formed by a float process for example and is preferred for mass production.

A melting method for production of the glass substrate of the present invention is as follows for example. That is, materials of the respective components to be usually used are measured and mixed so as to constituted the desired composition and then heat-melted in a glass melting furnace. The glass is homogenized by bubbling, stirring, adding a refining agent or the like.

For melting, a method by which the β—OH value of the glass will be high is employed. For example, the water content in the materials is increased, the water vapor concentration in the melting atmosphere is increased, the melting temperature is increased, or the melting time is prolonged. To increase the water content in the materials, it is effective to use a hydroxide as a material for example. To increase the water vapor concentration in the melting atmosphere, if the glass is melted by heating using a burner, it is effective to employ oxygen combustion system. Further, it is preferred not to employ electric melting system.

A forming/processing method for production of the glass substrate of the present invention is not particularly limited. The glass is formed into plate glass having a predetermined thickness by a conventional method such as a down draw method such as a fusion method, a float process of a press method, and then annealed. As the case requires, processing such as grinding or polishing is carried out to form a glass substrate having a predetermined size and shape. The forming method is particularly preferably a float process, which is suitable for mass production. Further, a continuous forming method other than a float process, i.e. a fusion method or a down draw method is also preferred.

### EXAMPLES

Now, the present invention will be described in further detail with reference to Examples. However, it should be understood that the present invention is by no means restricted to such specific Examples.

Materials of the respective components were measured and mixed so as to constitute glass having composition B comprising, as represented by mol %, 65.7% of is SiO₂, 8.5% of Al₂O₃, 12.4% of Li₂O, 10.9% of Na₂O and 2.5% of ZrO₂, and melted in a platinum crucible at a temperature of 1,570° C. for 4 hours. At the time of melting, a platinum stirrer was inserted in the molten glass, and the molten glass was stirred for 2 hours in usual air atmosphere to homogenize the glass. Then, the molten glass was flown out, formed into a plate and annealed to room temperature at a cooling rate of 1° C./minute to obtain plate glass in Example 1.

Further, materials of the respective components were measured and mixed in the same manner to obtain glass having composition B, and melted in a platinum crucible at a temperature of 1,570° C. for 4 hours. At the time of melting, a platinum stirrer was inserted in the molten glass, and the molten glass was stirred for 2 hours in an atmosphere of a gas having a nitrogen gas bubbled at a flow rate of 2.5 NI/minute in water heated to 60° C., to homogenize the glass. Then, the molten glass was flown out, formed into a plate and annealed to room temperature at a cooling rate of 1° C./minute to obtain plate glass in Example 2.

Further, materials of the respective components were measured and mixed in the same manner to obtain glass having composition B, and melted in a platinum crucible at a temperature of 1,570° C. for 4 hours. At the time of melting, a platinum stirrer was inserted in molten glass, and the molten glass was stirred for 2 hours in an atmosphere of a gas having a nitrogen gas bubbled at a flow rate of 2.5 NI/minute in water heated to 80° C., to homogenize the glass. Then, the molten glass was flown out, formed into a plate and annealed to room temperature at a cooling rate of 1° C./minute to obtain plate glass in Example 3.

With respect to plate glass in Examples 1, 2 and 3, the density d, the average linear expansion coefficient α, the Young's modulus E, the specific modulus E/d, the glass transition temperature T_{g}, the β—OH value and the weather resistance index C_{R} are shown in Table 1. They were measured by the following methods.

d: Measured by Archimedes' method by using from 20 to 50 g of glass having no bubble.

α: By using a differential thermal dilatometer and quartz glass as a reference material, the degree of elongation of glass at a time of raising the temperature from room temperature at a rate of 5° C./minute was measured until the temperature at which glass softened and elongation was no longer observed, i.e. the yield point, and an average linear expansion coefficient in a temperature range of from −50 to 70° C. was calculated from the obtained thermal expansion curve.

E: Measured by an ultrasonic pulse-echo method with respect to a glass plate having a thickness of from 5 to 10 mm and a size of 3 cm×3 cm.

T₉: By using a differential thermal dilatometer and quartz glass as a reference material, the degree of elongation of glass at a time of raising the temperature from room temperature at a rate of 5° C./minute was measured until the yield point, and a temperature at a critical point on the obtained thermal expansion curve was determined as a glass transition temperature.

β—OH value: Both sides of a glass plate having a thickness of from 1.5 to 2 mm and a size of 2 cm×2 cm were mirror-polished with cerium oxide, and then the transmission spectrum was measured by means of FT-IR. Then, the β—OH value was calculated from the above formula.

C^{R}: Both surfaces of a glass plate having a thickness of from 1 to 2 mm and a size of 4 cm×4 cm were mirror-polished with cerium oxide and washed with calcium carbonate and a detergent, and then the glass plate was put in a highly accelerate stress test system (unsaturated type pressure cracker EHS-411M, manufactured by ESPEC Corp.) and left under a steam atmosphere at 120° C. under 0.2 MPa for 20 hours. The tested sample and 20 ml of ultrapure water were put in a washed plastic bad provided with a zipper, a surface precipitate was dissolved with applying ultrasonic waves for 10 minutes, and eluted alkali components (Li, Na) were quantified by using ICP-MS. The amounts of the eluted alkali components were converted to mol and normalized with the surface area of the test sample, and the total of such amounts was regarded as C_{R}.

It is evident from Table 1 that the weather resistance is improved by the β—OH value being at least 0.20 mm⁻¹ even with glass having the same composition.

TABLE 1

| | Ex. | | |
|---|---|---|---|
| | 1 | 2 | 3 |
| SiO₂ | 65.7 | 65.7 | 65.7 |
| Al₂O₃ | 8.5 | 8.5 | 8.5 |
| Li₂O | 12.4 | 12.4 | 12.4 |
| Na₂O | 10.9 | 10.9 | 10.9 |
| ZrO₂ | 2.5 | 2.5 | 2.5 |
| R₂O | 23.3 | 23.3 | 23.3 |
| d | 2.50 | 2.50 | 2.49 |
| α | 78 | 77 | 77 |
| E | 84 | 84 | 85 |
| E/d | 33.7 | 33.8 | 33.9 |
| T_{g} | 494 | 488 | 483 |
| β-OH value | 0.14 | 0.26 | 0.38 |
| C_{R} | 8.7 | 7.9 | 7.8 |

The present invention is applicable to production of information recording media such as magnetic disks.

The entire disclosure of Japanese Patent Application No. 2009-292575 filed on Dec. 24, 2009 including specification, claims and summary is incorporated herein by reference in its entirety.

What is claimed is:

1. A glass substrate for an information recording medium, comprising an alkali aluminosilicate glass, wherein the β—OH value is at least 0.20 mm⁻¹.

2. The glass substrate for an information recording medium according to claim 1, wherein the alkali aluminosilicate glass has an alkali metal oxide content of from 15 to 26 mol %.

3. The glass substrate for an information recording medium according to claim 1, wherein the alkali aluminosilicate glass comprises, as represented by mol % based on the following oxides, from 64 to 67% of SiO₂, from 8 to 10% of Al₂O₃, from 10 to 13% of Li₂O, from 9 to 12% of Na₂O, from 0 to 2% of K₂O and from 2 to 4% of ZrO₂, provided that the total content of Li₂O, Na₂O and K₂O is from 21 to 25%.

4. The glass substrate for an information recording medium according to claim 1, wherein the β—OH value is at least 0.30 mm⁻¹.

5. A magnetic disk comprising the glass substrate for an information recording medium as defined in claim 1, and a magnetic recording layer formed on the glass substrate.
